(19) United States
(12) Patent Application Publication
(10) Pub. No.: US 2025/0065318 A1
(43) Pub. Date: Feb. 27, 2025

(54) CATALYTIC POROUS METAL OXIDE PARTICLES

(71) Applicant: BASF CORPORATION, Florham Park, NJ (US)

(72) Inventors: Wolfgang RUETTINGER, Iselin, NJ (US); Rupa Hiremath DARJI, Tarrytown, NY (US); Liangliang QU, Tarrytown, NY (US); Yuejin LI, Iselin, NJ (US)

(21) Appl. No.: 18/720,349

(22) PCT Filed: Dec. 20, 2022
(86) PCT No.: PCT/US2022/053552

§ 371 Date: Jun. 14, 2024

Related U.S. Application Data
(60) Provisional application No. 63/292,216, filed on Dec. 21, 2021.

(51) Int. Cl. B01J 37/00; B01J 23/44; B01J 35/61; B01J 35/63; B01J 35/69; B01J 37/02; B01J 37/08

(52) U.S. Cl. CPC B01J 37/0072; B01J 23/44; B01J 35/615; B01J 35/633; B01J 35/69; B01J 37/0018; B01J 37/0045; B01J 37/0201; B01J 37/084

(57) ABSTRACT

Catalytic porous metal oxide particles and methods of preparing the same.

### CROSS-REFERENCE TO RELATED APPLICATIONS

This application claims the benefit of priority of U.S. Provisional Application No. 63/292,216, filed on Dec. 21, 2021, the disclosure of which is hereby incorporated by reference herein in its entirety.

### TECHNICAL FIELD

This application relates to metal oxide particles having, for example, catalytic properties, as well as methods of preparing the same.

### BACKGROUND

The sintering of support materials and the collapse of the pore structure of alumina and rare earth-modified alumina still poses a problem for three-way catalyst (TWC) applications in vehicles. For platinum group metal (PGM) catalysts in particular, the collapse of the pore structure buries PGM particles which reduces effective PGM surface area, leading to increased pore diffusional resistance in the catalyst. Therefore, there remains a need for novel catalyst support materials with an exceptionally high thermal stability and available anchoring points for PGMs.

### SUMMARY OF THE INVENTION

The following summary presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect, a method of forming catalytic microspheres comprises: generating liquid droplets from an aqueous dispersion comprising a polymer material, a metal oxide material or precursor, and a catalytic metal material or precursor; drying the liquid droplets to provide dried particles comprising the polymer material, the metal oxide material or precursor, and the catalytic metal material or precursor; and calcining or sintering the dried particles to remove the polymer material and form the metal oxide microspheres each comprising a matrix of the metal oxide defining a porous network. In at least one embodiment, the calcining or sintering results in the formation of catalytic metal or metal oxide nanoparticles within the catalytic microspheres.

In another aspect, a method of forming catalytic microspheres comprises: generating liquid droplets from an aqueous dispersion comprising a polymer material and a metal oxide material or precursor; drying the liquid droplets to provide dried particles comprising the polymer material, the metal oxide material or precursor, and the catalytic metal material or precursor; calcining or sintering the dried particles to remove the polymer material and form the metal oxide microspheres each comprising a matrix of the metal oxide defining a porous network; introducing a catalytic metal material or precursor into a porous network within the metal oxide microspheres to form impregnated microspheres; and drying and calcining the impregnated microspheres to form the catalytic microspheres. In at least one embodiment, calcining the impregnated microspheres results in the formation of catalytic metal or metal oxide nanoparticles within the catalytic microspheres. In at least one embodiment, introducing the catalytic metal material or precursor into the porous network comprises utilizing an incipient wetness impregnation process.

In at least one embodiment, the porous network is an ordered or partially ordered array of macropores. In at least one embodiment, the porous network is a disordered array of macropores.

In at least one embodiment, the catalytic metal material or precursor comprises a catalytic metal selected from platinum, palladium, rhodium, copper, manganese, nickel, cobalt, zinc, indium, gallium, zirconium, cerium, vanadium, molybdenum, or rhenium.

In at least one embodiment, an average surface area of the catalytic microspheres is greater than about 100 m²/g.

In at least one embodiment, a cumulative pore volume of the catalytic microspheres is greater than 0.3 mL/g.

In at least one embodiment, the catalytic microspheres comprise a bimodal pore distribution of macropores and mesopores, wherein an average pore radius of the mesopores is from about 10 Å to about 100 Å.

In at least one embodiment, the polymer material comprises a polymer selected from poly(meth)acrylic acid, poly(meth)acrylates, polymethyl methacrylate polystyrenes, polyacrylamides, polyethylene, polypropylene, polylactic acid, polyacrylonitrile, a co-polymer of methyl methacrylate and [2-(methacryloyloxy)ethyl]trimethylammonium chloride, derivatives thereof, salts thereof, copolymers thereof, or mixtures thereof.

In at least one embodiment, the polymer material is in the form of nanoparticles, and wherein the nanoparticles have an average diameter from about 50 nm to about 500 nm.

In at least one embodiment, the metal oxide material or precursor comprises a metal oxide selected from silica, titania, alumina, zirconia, ceria, iron oxides, zinc oxide, indium oxide, tin oxide, chromium oxide, or combinations thereof.

In at least one embodiment, the metal oxide material is in the form of metal oxide particles having an average diameter from about 1 nm to about 120 nm.

In at least one embodiment, the catalytic microspheres have an average diameter from about 0.5 μm to about 100 μm.

In at least one embodiment, generating the liquid droplets is performed using a microfluidic process.

In at least one embodiment, generating and drying the liquid droplets is performed using a spray-drying process.

In at least one embodiment, generating the liquid droplets is performed using a vibrating nozzle.

In at least one embodiment, drying the droplets comprises evaporation, microwave irradiation, oven drying, drying under vacuum, drying in the presence of a desiccant, or a combination thereof.

In at least one embodiment, the particle dispersion is an aqueous particle dispersion.

In at least one embodiment, a weight to weight ratio of the polymer material to the metal oxide material or precursor is from about 1/10 to about 10/1, or from about 1/10 to about 10/1.

Another aspect relates to catalytic microspheres being prepared by any of the foregoing processes.

Another aspect relates to catalytic microspheres each comprising a metal oxide matrix defining an array of macropores and a plurality of catalytic metal nanoparticles formed at least partially within mesopores of the metal oxide matrix.

In at least one embodiment, the catalytic metal nanoparticles are formed substantially within the mesopores of the metal oxide matrix.

In at least one embodiment, the array of macropores is an ordered or partially ordered array of macropores. In at least one embodiment, the array of macropores is a disordered array of macropores.

In at least one embodiment, the catalytic metal or metal oxide nanoparticles comprise a catalytic metal selected from platinum, palladium, rhodium, copper, manganese, nickel, cobalt, zinc, indium, gallium, zirconium, cerium, vanadium, molybdenum, or rhenium.

In at least one embodiment, an average surface area of the catalytic microspheres is greater than about 100 m²/g.

In at least one embodiment, a cumulative pore volume of the catalytic microspheres is greater than 0.3 mL/g.

In at least one embodiment, an average pore radius of the mesopores is from about 10 Å to about 100 Å.

In at least one embodiment, the metal oxide comprises a metal oxide selected from silica, titania, alumina, zirconia, ceria, iron oxides, zinc oxide, indium oxide, tin oxide, chromium oxide, or combinations thereof.

In at least one embodiment, the catalytic microspheres have an average diameter from about 0.5 μm to about 100 μm.

In at least one embodiment, the catalytic metal or catalytic metal nanoparticles are present in the catalytic microspheres at no greater than about 0.5 wt %, no greater than about 0.45 wt %, no greater than about 0.40 wt %, no greater than about 0.35 wt %, no greater than about 0.30 wt %, no greater than about 0.25 wt %, no greater than about 0.20 wt %, no greater than about 0.15 wt %, no greater than about 0.125 wt %, no greater than about 0.1 wt %, no greater than about 0.075 wt %, no greater than about 0.05 wt %, or within any range defined by any of these endpoints (e.g., from about 0.1 wt % to about 0.5 wt %), calculated as metal weight based on the total weight of the catalytic microspheres.

In at least one embodiment, the catalytic metal or the catalytic metal nanoparticles comprise rhodium.

In at least one embodiment, the catalytic microspheres exhibit a catalytic activity within about 1%, about 5%, or about 10% of a catalytic activity for a comparative catalyst formed by impregnation of the catalytic metal onto a metal oxide support having a disordered and non-uniform pore structure and subsequent calcination, wherein a loading of the catalytic metal on the catalytic microspheres is at least about 10%, at least about 20%, at least about 30%, at least about 40%, or at least about 50% lower than a loading of the catalytic metal on the comparative catalyst.

In another aspect, a composition comprising the catalytic microspheres of any of the foregoing embodiments. In at least one embodiment, the composition further comprises a substrate having the catalytic microspheres disposed thereon.

In another aspect, a catalytic devices comprises: a substrate; and the catalytic microspheres of any of the foregoing embodiments.

In another aspect, a method of forming a catalytic device comprises: forming a slurry comprising the catalytic microspheres of any of any of the foregoing embodiments and a binder; depositing a washcoat layer of the slurry on a substrate to form a coated substrate; and calcining the substrate to form the catalytic device.

Unless otherwise defined, all technical terms used herein have the same meaning as commonly understood by one of ordinary skill in the art to which this disclosure belongs.

As used herein, the term “bulk sample” refers to a population of particles. For example, a bulk sample of particles is simply a bulk population of particles, for example, ≥0.1 mg, ≥0.2 mg, ≥0.3 mg, ≥0.4 mg, ≥0.5 mg, ≥0.7 mg, ≥1.0 mg, ≥2.5 mg, ≥5.0 mg, ≥10.0 mg, or ≥25.0 mg. A bulk sample of particles may be substantially free of other components. The terms “catalytic microspheres,” “porous microspheres,” and the like may mean a bulk sample.

Also as used herein, the term “precursor,” such as precursors used in the formation of metal oxides, refers to a compound that exists in a liquid state but can form a solid material under specific reaction conditions. For example, colloidal metal oxide particles may be formed via a sol-gel process by subjecting a metal alkoxide precursor to hydrolysis and polycondensation reactions.

Also as used herein, the term “substrate” refers to a material (e.g., a metal, semi-metal, semi-metal oxide, metal oxide, polymeric, ceramic, paper, pulp/semi-pulp products, etc.) onto or into which the catalyst is placed. In certain embodiments, the substrate may be in the form of a solid surface having a washcoat containing a plurality of catalytic particles and/or adsorbent particles. A washcoat may be formed by preparing a slurry containing a specified solids content (e.g., 30-50% by weight) of catalytic particles and/or adsorbent particles, which is then coated onto a substrate and dried to provide a washcoat layer. In certain embodiments, the substrate may be porous and the washcoat may be deposited outside and/or inside the pores.

Also as used herein, the term “dispersant” refers to a compound that helps to maintain solid particles in a state of suspension in a fluid medium, and inhibits or reduces agglomeration or settling of the particles in the fluid medium.

Also as used herein, the term “binder” refers to a material that, when included in a coating, layer, or film (e.g., a washcoated coating, layer, or film on a substrate), promotes the formation of a continuous or substantially continuous structure from one outer surface of the coating, layer, or film through to the opposite outer surface, is homogeneously or semi-homogeneously distributed in the coating, layer, or film, and promotes adhesion to a surface on which the coating, layer, or film is formed and cohesion between the surface and the coating, layer, or film.

Surface area, as discussed herein, is determined by the Brunauer-Emmett-Teller (BET) method according to DIN ISO 9277:2003-05 (which is a revised version of DIN 66131), which may be referred to as “BET surface area.” The specific surface area is determined by a multipoint BET measurement in the relative pressure range from 0.05-0.3 p/p₀.

Pore volume and average pore radius, as discussed herein, are determined by the Barret-Joyner-Halenda (BJH) method. Mercury porosimetry analysis can be used to characterize porosity. Mercury porosimetry applies controlled pressure to a sample immersed in mercury. External pressure is applied for the mercury to penetrate into the voids/pores of the material. The amount of pressure required to intrude into the voids/pores is inversely proportional to the size of the voids/pores. A mercury porosimeter generates volume and pore size distributions from the pressure versus intrusion data generated by the instrument using the Washburn equation:

$$D = \frac{- 4 g cos q}{P} ,$$

where D=diameter, P=pressure, g=surface tension of mercury, q=contact angle. For example, porous silica microspheres containing voids/pores with an average size of about 165 nm can have an average porosity of about 0.8.

Also as used herein, the terms “particles,” “microspheres,” “microparticles,” “nanospheres,” “nanoparticles,” “droplets,” etc., may refer to, for example, a plurality thereof, a collection thereof, a population thereof, a sample thereof, or a bulk sample thereof. The terms “spheres” and “particles” may be interchangeable.

Also as used herein, the terms “micro” or “micro-scaled,” for example, when referring to particles, mean from 1 micrometer (μm) to less than 1000 μm. The term “nano” or “nano-scaled,” for example, when referring to particles, mean from 1 nanometer (nm) to less than 1000 nm.

Also as used herein, terms related to physical dimensions, such as particle diameter and particle radius, may be determined, for instance, by scanning electron microscopy (SEM) or transmission electron microscopy (TEM). Average particle size is synonymous with D50, meaning half of the population resides above this point, and half below. Particle size may also be measured by laser light scattering techniques, with dispersions or dry powders.

Also as used herein, the term “mesopores” refers to a population of pores having an average diameter in the range of greater than 10 Angstroms to 500 Angstroms, as measured by the BJH method.

Also as used herein, the term “macropores” refers to a population of pores having an average diameter in the range of greater than 500 Angstroms. Macropore sizes may be measured, for example, via electron microscopy.

Also as used herein, the term “monodisperse” in reference to a population of particles means particles having generally uniform shapes and generally uniform diameters. A monodisperse population of particles, for example, may have 90%, 91%, 92%, 93%, 94%, 95%, 96%, 97%, 98% m or 99% of the particles by number having diameters within +7%, ±6%, ±5%, ±4%, ±3%, ±2%, or ±1% of the average diameter of the population.

Also as used herein, the term “substantially free of other components” means containing, for example, ≤5%, ≤4%, ≤3%, ≤2%, ≤1%, ≤0.5%, ≤0.4%, ≤0.3%, ≤0.2%, or ≤ 0.1% by weight of other components.

Also as used herein, the term “of” may mean “comprising.” For example, “a liquid dispersion of” may be interpreted as “a liquid dispersion comprising.”

The articles “a” and “an” used herein refer to one or to more than one (e.g., at least one) of the grammatical object. Any ranges cited herein are inclusive.

Also as used herein, the term “about” is used to describe and account for small fluctuations. For example, “about” may mean the numeric value may be modified by +5%, +4%, ±3%, ±2%, ±1%, ±0.5%, ±0.4%, ±0.3%, ±0.2%, ±0.1%, or ±0.05%. All numeric values are modified by the term “about” whether or not explicitly indicated. Numeric values modified by the term “about” include the specific identified value. For example, “about 5.0” includes 5.0.

Unless otherwise indicated, all parts and percentages are by weight. Weight percent (wt. %), if not otherwise indicated, is based on an entire composition free of any volatiles, that is, based on dry solids content.

U.S. patents, U.S. patent applications and published U.S. patent applicants discussed herein are hereby incorporated by reference.

### BRIEF DESCRIPTION OF DRAWINGS

The disclosure described herein is illustrated by way of example and not by way of limitation in the accompanying figures.

FIG. 1 illustrates an exemplary process of preparing porous metal oxide particles.

FIG. 2 shows a schematic of an exemplary spray drying system used in accordance with various embodiments of the present disclosure.

FIG. 3 is a scanning electron microscope (SEM) image of a polymer template microsphere.

FIG. 4 is a SEM image of a porous silica microsphere after calcination.

FIG. 5 illustrates an exemplary process of preparing catalytic microspheres in accordance with at least one embodiment.

FIG. 6 illustrates liquid droplets and dried particles formed as a result of modifying the spray drying process of FIG. 2 to further include catalytic metal material or catalytic metal precursor in accordance with at least one embodiment.

FIG. 7 is an SEM image of a catalytic alumina microsphere after calcination prepared in accordance with at least one embodiment.

FIG. 8 is an SEM image of surface topology of a fresh Rh-alumina catalyst with ordered and uniform pore structure prepared in accordance with at least one embodiment.

FIG. 9 is an SEM image of surface topology of an aged Rh-alumina catalyst with ordered and uniform pore structure prepared in accordance with at least one embodiment.

FIG. 10 is an SEM image of surface topology of a fresh Rh-alumina catalyst reference sample.

FIG. 11 is an SEM image of surface topology of an aged Rh-alumina catalyst reference sample.

FIG. 12 shows diffuse reflectance infrared Fourier transform spectra of CO adsorbed on a fresh Rh catalyst, prepared in accordance with at least one embodiment, and a fresh comparative catalyst.

FIG. 13 shows diffuse reflectance infrared Fourier transform spectra of CO adsorbed on an aged Rh catalyst, prepared in accordance with at least one embodiment, and an aged comparative catalyst.

### DETAILED DESCRIPTION

Embodiments of the present disclosure are directed catalytic particles (e.g., microspheres), and more specifically, to porous metal oxide particles (e.g., nanospheres or microspheres having an inverse opal structure) having catalytic components contained therein. For example, in at least one embodiment, a catalytic microsphere is formed from a metal oxide matrix defining an array of macropores. Catalytic metal nanoparticles can be disposed within the macropores (e.g., on gas or liquid accessible surfaces of the metal oxide matrix, within mesopores of the metal oxide matrix, or a combination thereof. The embodiments of the present disclosure demonstrate the use of inverse opal structures produced as spherical particles that can advantageously support catalytic particles (such as PGM particles) for TWC or other catalytic applications.

Metal oxide particles (e.g., nanospheres or microspheres) used in the embodiments of the present disclosure may be prepared with the use of a polymeric sacrificial template. In one embodiment, an aqueous colloid dispersion containing polymer particles and a metal oxide is prepared, the polymer particles typically being nano-scaled. The aqueous colloidal dispersion is mixed with a continuous oil phase, for instance within a microfluidic device, to produce a water-in-oil emulsion. Emulsion aqueous droplets are prepared, collected and dried to form microspheres containing polymer nanoparticles and metal oxide. The polymer nanoparticles (nanospheres) are then removed, for instance via calcination, to provide spherical, micron-scaled metal oxide particles (microspheres) containing a high degree of porosity and nano-scaled pores. The microspheres may contain uniform pore diameters, a result of the polymer particles being spherical and monodisperse.

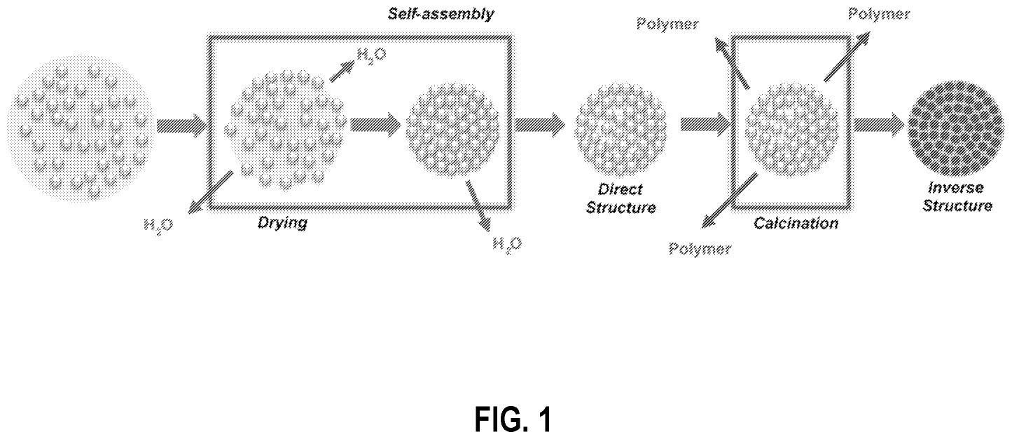

The metal oxide particles described herein may be prepared as described in U.S. Pat. Nos. 11,179,694 and 11,185,835, the disclosures of which are incorporated by reference herein in their entireties. FIG. 1 illustrates an exemplary process of preparing porous metal oxide particles. An emulsion droplet containing polymer particles (e.g., nanospheres) and metal oxide is dried to remove solvent, providing an assembled microsphere containing polymer particles with metal oxide in the interstitial spaces between the polymer particles (template microsphere or “direct structure”). The polymer particles define the interstitial space. Calcination results in removal of the polymer, providing a present metal oxide microsphere with high porosity, or void volume (inverse structure). In at least one embodiment, the metal oxide may be in the form of particles or produce via a precursor, such as a metal alkoxide or metal chloride. The porous metal oxide microspheres may be advantageously calcined or sintered, resulting in a continuous solid structure which is thermally and mechanically stable.

In at least one embodiment, the droplets comprise polymer particles dispersed in a solution of a metal oxide precursor, such as a metal alkoxide. Hydrolysis of the metal oxide precursor forms an intermediate that serves as a matrix in which the polymer particles are embedded. The structure is then heated to undergo hydrolysis and condensation of the matrix, resulting in the formation of a continuous matrix of metal oxide. In an illustrative example, polymer particles (e.g., polystyrene particles) are initially dispersed in a solution of tetraethyl orthosilicate (TEOS). Heating converts the TEOS to silica, resulting in the formation of a continuous matrix of silica in which the polymer particles are embedded. In a further illustrative example, polymer particles (e.g., polymethyl methacrylate particles) are initially dispersed in a solution containing boehmite. Calcining converts the boehmite to alumina, resulting in the formation of a continuous matrix of alumina having a porous network formed therein.

In certain embodiments, droplet formation and collection occur within a microfluidic device. Microfluidic devices are, for example, narrow channel devices having a micron-scaled droplet junction adapted to produce uniform size droplets, with the channels being connected to a collection reservoir. Microfluidic devices, for example, contain a droplet junction having a channel width of from about 10 μm to about 100 μm. The devices are, for example, made of polydimethylsiloxane (PDMS) and may be fabricated, for example, via soft lithography. An emulsion may be prepared within the device via pumping an aqueous dispersed phase and oil continuous phase at specified rates to the device where mixing occurs to provide emulsion droplets. Alternatively, an oil-in-water emulsion may be utilized. The continuous oil phase comprises, for example, an organic solvent, a silicone oil, or a fluorinated oil. As used herein, “oil” refers to an organic phase (e.g., an organic solvent) immiscible with water. Organic solvents include hydrocarbons, for example, heptane, hexane, toluene, xylene, and the like.

In certain embodiments with liquid droplets, the droplets are formed with a microfluidic device. The microfluidic device can contain a droplet junction having a channel width, for example, of from any of about 10 μm, about 15 μm, about 20 μm, about 25 μm, about 30 μm, about 35 μm, about 40 μm, or about 45 μm to any of about 50 μm, about 55 μm, about 60 μm, about 65 μm, about 70 μm, about 75 μm, about 80 μm, about 85 μm, about 90 μm, about 95 μm, or about 100 μm.

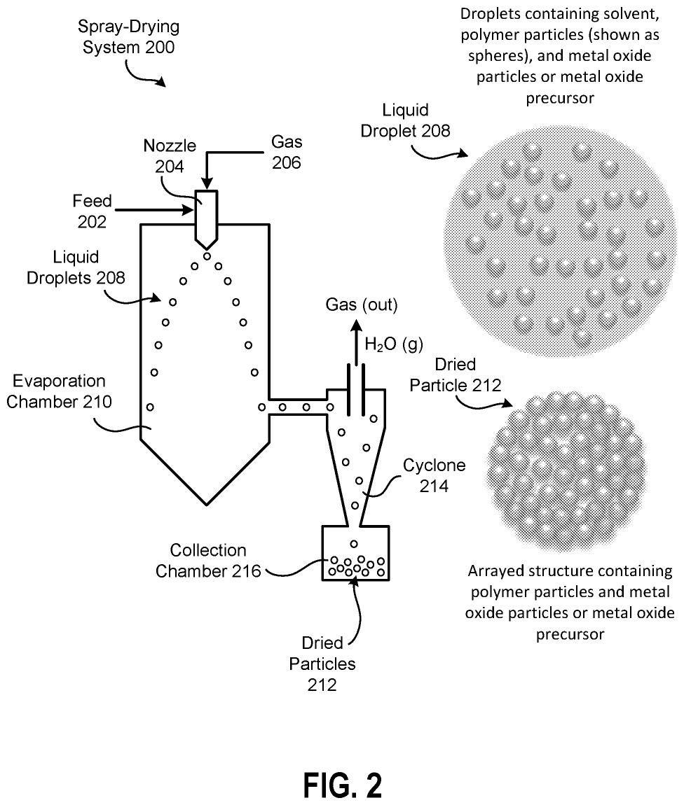

In certain embodiments, generating and drying the liquid droplets is performed using a spray-drying process. FIG. 2 shows a schematic of an exemplary spray drying system 200 used in accordance with various embodiments of the present disclosure. In certain embodiments of spray-drying techniques, a feed 202 of a liquid solution or dispersion is fed (e.g. pumped) to an atomizing nozzle 204 associated with a compressed gas inlet through which a gas 206 is injected. The feed 202 is pumped through the atomizing nozzle 204 to form liquid droplets 208. The liquid droplets 208 are surrounded by a pre-heated gas in an evaporation chamber 210, resulting in evaporation of solvent to produce dried particles 212. The dried particles 212 are carried by the drying gas through a cyclone 214 and deposited in a collection chamber 216. Gases include nitrogen and/or air. In an embodiment of an exemplary spray-drying process, a liquid feed contains a water or oil phase, the metal oxide, and the polymer particles. The dried particles 212 comprise a self-assembled structure of each polymer particle surrounded by metal oxide particles.

Air may be considered a continuous phase with a dispersed liquid phase (a liquid-in-gas emulsion). In certain embodiments, spray-drying comprises an inlet temperature of from any of about 100° C., about 105° C., about 110° C., about 115° C., about 120° C., about 130° C., about 140° C., about 150° C., about 160° C., or about 170° C. to any of about 180° C., about 190° C., about 200° C., about 210° C., about 215° C., or about 220° C. In some embodiments a pump rate (feed flow rate) of from any of about 1 mL/min, about 2 mL/min, about 5 mL/min, about 6 mL/min, about 8 mL/min, about 10 mL/min, about 12 mL/min, about 14 mL/min, or about 16 mL/min to any of about 18 mL/min, about 20 mL/min, about 22 mL/min, about 24 mL/min, about 26 mL/min, about 28 mL/min, or about 30 mL/min is utilized.

In some embodiments, vibrating nozzle techniques may be employed. In such techniques, a liquid dispersion is prepared, and then droplets are formed and dropped into a bath of a continuous phase. The droplets are then dried. Vibrating nozzle equipment is available from BÜCHI and comprises, for example, a syringe pump and a pulsation unit. Vibrating nozzle equipment may also comprise a pressure regulation valve.

Suitable polymers forming the polymer particles include thermoplastic polymers. For example, polymer particles may comprise a polymer selected from poly(meth)acrylic acid, poly(meth)acrylates, polystyrenes, polyacrylamides, polyvinyl alcohol, polyvinyl acetate, polyesters, polyurethanes, polyethylene, polypropylene, polylactic acid, polyacrylonitrile, polyvinyl ethers, derivatives thereof, salts thereof, copolymers thereof, or combinations thereof. For example, the polymer is selected from polymethyl methacrylate, polyethyl methacrylate, poly(n-butyl methacrylate), polystyrene, poly(chloro-styrene), poly(alpha-methylstyrene), poly(N-methylolacrylamide), styrene/methyl methacrylate copolymer, polyalkylated acrylate, polyhydroxyl acrylate, polyamino acrylate, polycyanoacrylate, polyfluorinated acrylate, poly(N-methylolacrylamide), polyacrylic acid, polymethacrylic acid, methyl methacrylate/ethyl acrylate/acrylic acid copolymer, styrene/methyl methacrylate/acrylic acid copolymer, polyvinyl acetate, polyvinylpyrrolidone, polyvinylcaprolactone, polyvinylcaprolactam, a co-polymer of methyl methacrylate and [2-(methacryloyloxy)ethyl]trimethylammonium chloride, derivatives thereof, salts thereof, or combinations thereof.

The polymer particles, for instance, have an average diameter of from about 50 nm to about 999 nm and can be monodisperse or polydisperse. In at least one embodiment, the polymer particles have an average diameter of from any of about 50 nm, about 75 nm, about 100 nm, about 130 nm, about 160 nm, about 190 nm, about 210 nm, about 240 nm, about 270 nm, about 300 nm, about 330 nm, about 360 nm, about 390 nm, about 410 nm, about 440 nm, about 470 nm, about 500 nm, about 530 nm, about 560 nm, about 590 nm, or about 620 nm to any of about 650 nm, about 680 nm, about 710 nm, about 740 nm, about 770 nm, about 800 nm, about 830 nm, about 860 nm, about 890 nm, about 910 nm, about 940 nm, about 970 nm or about 990 nm, or within any range defined therebetween (e.g., from about 190 nm to about 410 nm).

In certain embodiments, the metal oxide material is selected from silica, titania, alumina, zirconia, ceria, iron oxides, zinc oxide, indium oxide, tin oxide, chromium oxide, or combinations thereof. In certain embodiments, the metal oxide comprises titania, silica, or a combination thereof.

In embodiments that utilize metal oxide particles, the metal oxide particles can have an average diameter of about 1 nm, about 5 nm, about 10 nm, about 15 nm, about 20 nm, about 25 nm, about 30 nm, about 35 nm, about 40 nm, about 45 nm, about 50 nm, about 55 nm, or about 60 nm to about 65 nm, about 70 nm, about 75 nm, about 80 nm, about 85 nm, about 90 nm, about 95 nm, about 100 nm, about 105 nm, about 110 nm, about 115 nm, or about 120 nm. In other embodiments, the metal oxide particles have an average diameter of about 5 nm to about 150 nm, about 50 to about 150 nm, or about 100 to about 150 nm.

In embodiments that utilize metal oxide precursors, suitable metal oxide precursors may be, for example, tetraethyl orthosilicate (TEOS) or tetramethyl orthosilicate (TMOS) as a silica precursor, titanium propoxide as a titania precursor, or zirconium acetate as a zirconium precursor. During droplet formation, the liquid droplets can be dried to provide dried particles comprising a hydrolyzed precursor of metal oxide that surrounds and coats the polymer particles. The dried particles are then heated to calcine or sinter the metal oxide via a condensation reaction of the hydrolyzed precursor, and to remove the polymer particles via calcination.

In some embodiments, the evaporation of the liquid medium may be performed in the presence of self-assembly substrates such as conical tubes or silicon wafers. In certain embodiments, dried particle mixtures may be recovered, e.g., by filtration or centrifugation. In some embodiments, the drying comprises microwave irradiation, oven drying, drying under vacuum, drying in the presence of a desiccant, or a combination thereof.

In certain embodiments, a weight to weight ratio of the metal oxide material to the polymer material (after drying and, if a precursor is used, densification of the metal oxide precursor) is from about 1/10, about 2/10, about 3/10, about 4/10, about 5/10 about 6/10, about 7/10, about 8/10, about 9/10, to about 10/9, about 10/8, about 10/7, about 10/6, about 10/5, about 10/4, about 10/3, about 10/2, or about 10/1. In certain embodiments, the weight to weight ratio of the metal oxide material to the polymer material is 1/3, 2/3, 1/1, or 3/2.

In certain embodiments, polymer removal may be performed, for example, via calcination, pyrolysis, or with a solvent (solvent removal). Calcination is performed in some embodiments at temperatures of at least about 200° C., at least about 500° C., at least about 1000° C., from about 200° C. to about 1200° C., or from about 200° C. to about 700° C. The calcining can be for a suitable period, e.g., from about 0.1 hour to about 12 hours or from about 1 hour to about 8.0 hours. In other embodiments, the calcining can be for at least about 0.1 hour, at least about 1 hour, at least about 5 hours, or at least about 10 hours. In other embodiments, the calcining can be from any of about 200° C., about 350° C., about 400° C., 450° C., about 500° C. or about 550° C. to any of about 600° C., about 650° C., about 700° C., or about 1200° C. for a period of from any of about 0.1 h (hour), about 1 h, about 1.5 h, about 2.0 h, about 2.5 h, about 3.0 h, about 3.5 h, or about 4.0 h to any of about 4.5 h, about 5.0 h, about 5.5 h, about 6.0 h, about 6.5 h, about 7.0 h, about 7.5 h about 8.0 h, or about 12 h. While the polymer is removed during this process, an array of macropores will be substantially maintained and left behind after the calcination. In at least one embodiment, macropores in the porous metal oxide particles may be arranged in an ordered matter (e.g., hexagonally packed). Macropore order may be achieved, for example, by slowly performing the drying step of FIG. 1. A disordered (amorphous) arrangement of macropores may be achieved, for example, by utilizing polydisperse particles and/or by performing the drying step of FIG. 1 quickly.

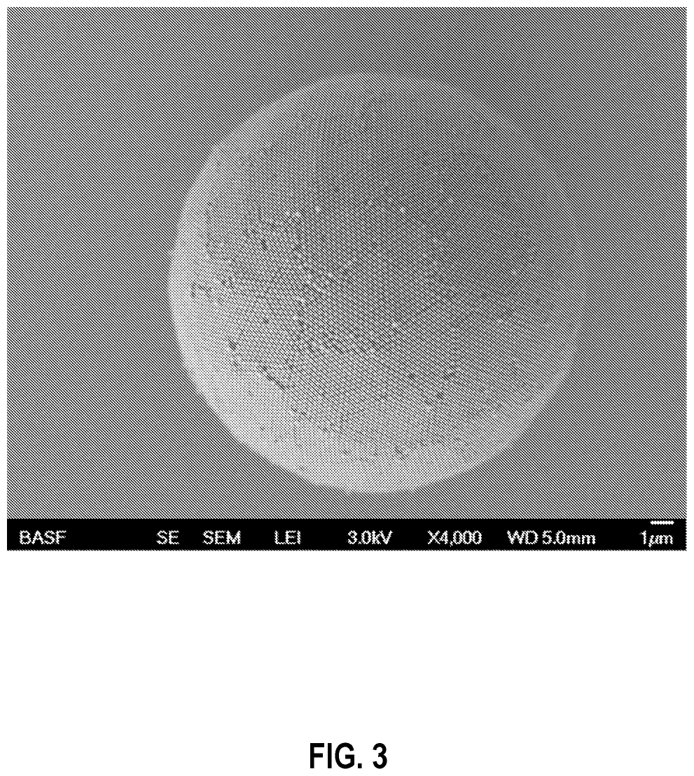

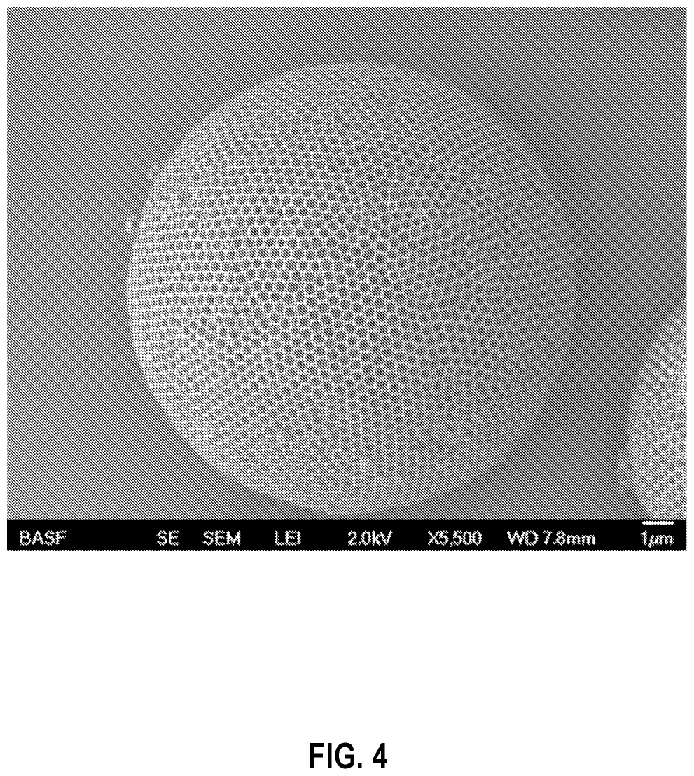

FIGS. 3 and 4 are, respectively scanning electron microscope (SEM) images of a polymer template microsphere (before calcination) and a porous silica microsphere (after calcination) prepared in accordance with the methods described herein.

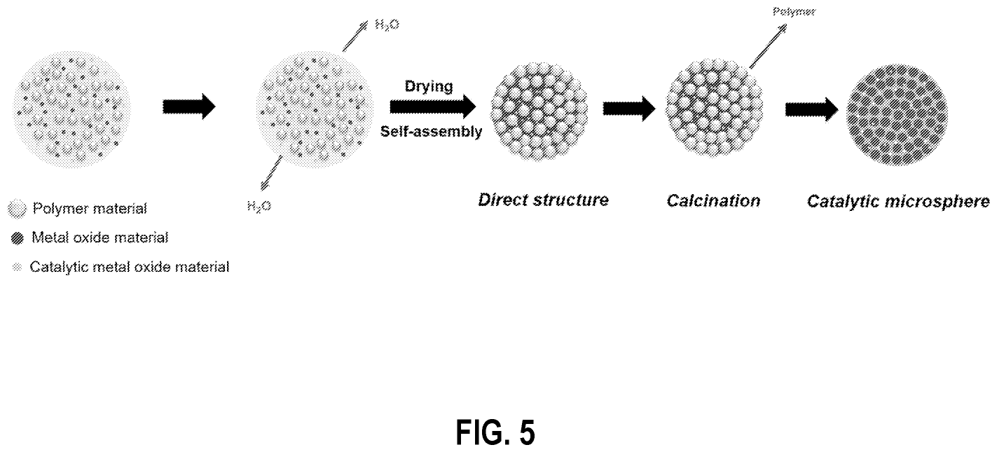

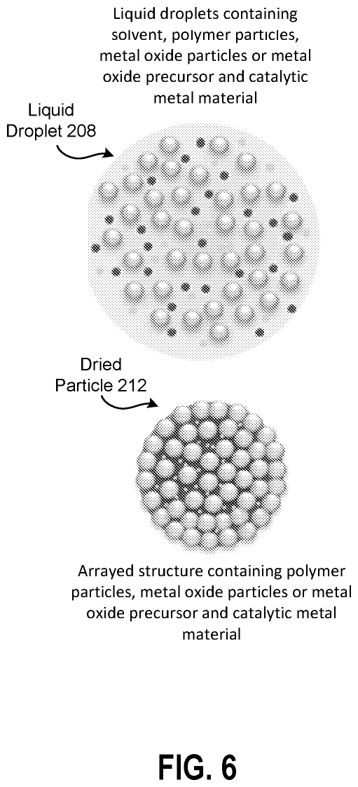

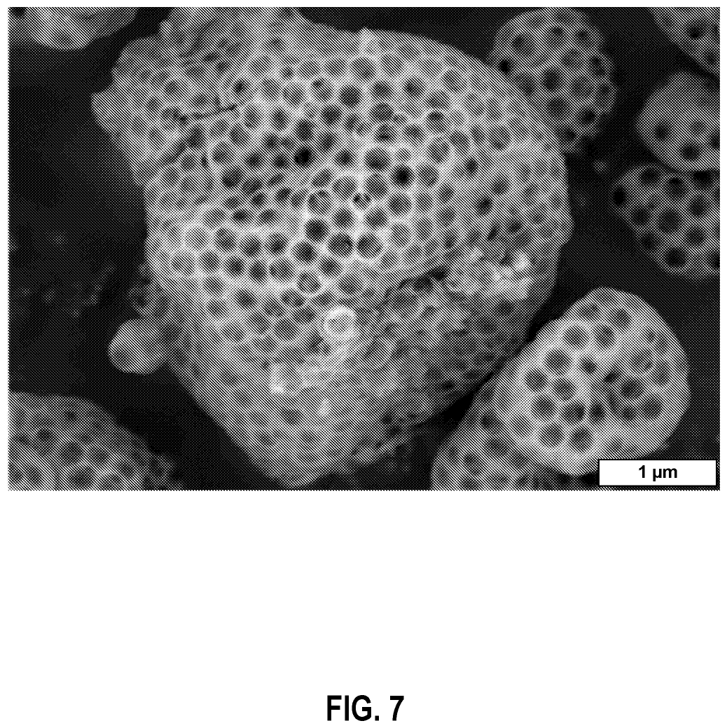

In at least one embodiment, the droplets process of FIG. 1 can be modified to produce catalytic porous metal oxide particles (e.g., catalytic microspheres), for example, as illustrated in FIG. 5. For example, in at least one embodiment, catalytic nanoparticles may be initially mixed together with polymer particles and metal oxide particles or a metal oxide precursor to form liquid droplets. The spray-drying system 200, when modified accordingly, will result in the liquid droplets 208 containing solvent, polymer particles, metal oxide particles or metal oxide precursor and catalytic metal material, and the dried particles being an arrayed structure containing polymer particles, metal oxide particles or metal oxide precursor, and catalytic metal material, as illustrated in FIG. 6. Drying and calcination/sintering may be performed in a similar manner as described with FIG. 1. This modified process can result in the immobilization of catalytic nanoparticles in the macropores and mesopores of the resulting metal oxide matrix. FIG. 7 is an SEM image of a catalytic alumina microsphere after calcination prepared in accordance with at least one embodiment.

In at least one embodiment, the metal of the catalytic metal particles is selected from platinum, palladium, rhodium, copper, manganese, nickel, cobalt, zinc, indium, gallium, zirconium, cerium, vanadium, molybdenum, rhenium, or combinations thereof. In at least one embodiment, the catalytic metal particles comprise a catalytic metal or a catalytic metal oxide. In at least one embodiment, the catalytic metal or catalytic metal oxide is present in the catalytic microspheres from about 0.1 wt. % to about 20 wt. %, about 0.2 wt. % to about 10 wt. %, or about 0.5 wt. %. to about 5 wt. %.

In at least one embodiment, the metal nanoparticles can have an average diameter of about 1 nm, about 5 nm, about 10 nm, about 15 nm, about 20 nm, about 25 nm, about 30 nm, about 35 nm, about 40 nm, about 45 nm, about 50 nm, about 55 nm, or about 60 nm to about 65 nm, about 70 nm, about 75 nm, about 80 nm, about 85 nm, about 90 nm, about 95 nm, about 100 nm, about 105 nm, about 110 nm, about 115 nm, or about 120 nm. In other embodiments, the metal oxide particles have an average diameter of about 5 nm to about 150 nm, about 50 to about 150 nm, or about 100 to about 150 nm.

In at least one embodiment, the metal nanoparticles can be loaded into porous metal oxide particles via an incipient wetness impregnation method.

A catalytic metal precursor may be used to form catalytic metal nanoparticles within porous microspheres in situ, for example, as a result of calcining or sintering. For example, in at least one embodiment, a metal precursor (e.g., tetraamine-palladium-hydroxide, palladium nitrate, etc.) is mixed with polymer particles and metal oxide particles/precursor. In at least one embodiment, the metal precursor may be introduced into porous metal oxide particles via an incipient wetness impregnation method, followed by a calcination step to effect the formation of the catalytic metal.

The catalytic microspheres may be micron-scaled, for example, having average diameters from about 0.5 μm to about 100 μm. In certain embodiments, the catalytic microspheres have an average diameter from about 0.5 μm, about 0.6 μm, about 0.7 μm, about 0.8 μm, about 0.9 μm, about 1.0 μm, about 5.0 μm, about 10 μm, about 20 μm, about 30 μm, about 40 μm, about 50 μm, about 60 μm, about 70 μm, about 80 μm, about 90 μm, about 100 μm, or within any range defined by any of these average diameters (e.g., about 1.0 μm to about 20 μm, about 5.0 μm to about 50 μm, etc.).

In certain embodiments, the catalytic microspheres have an average diameter of from about 1 μm to about 75 μm, from about 2 μm to about 70 μm, from about 3 μm to about 65 μm, from about 4 μm to about 60 μm, from about 5 μm to about 55 μm or from about 5 μm to about 50 μm; for example from any of about 5 μm, about 6 μm, about 7 μm, about 8 μm, about 9 μm, about 10 μm, about 11 μm, about 12 μm, about 13 μm, about 14 μm or about 15 μm to any of about 16 μm, about 17 μm, about 18 μm, about 19 μm, about 20 μm, about 21 μm, about 22 μm, about 23 μm, about 24 μm or about 25 μm.

In certain embodiments, the catalytic microspheres have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm or about 7.5 μm to any of about 7.8 μm about 8.1 μm, about 8.4 μm, about 8.7 μm, about 9.0 μm, about 9.3 μm, about 9.6 μm or about 9.9 μm.

In at least one embodiment, the catalytic microspheres have an average surface area (BET surface area) of greater than about 100 m²/g. In at least one embodiment, the catalytic microspheres have an average surface area of about 100 m²/g, about 150 m²/g, about 200 m²/g, about 250 m²/g, about 300 m²/g, about 350 m²/g, about 400 m²/g, about 450 m²/g, about 500 m²/g, about 550 m²/g, about 600 m²/g, about 650 m²/g, about 700 m²/g, about 750 m²/g, about 800 m²/g, about 850 m²/g, about 900 m²/g, about 950 m²/g, about 1000 m²/g, or greater, or in any range defined therebetween (e.g., about 250 m²/g to about 400 m²/g, etc.).

In at least one embodiment, the catalytic microspheres have an average cumulative pore volume (BJH pore volume) of greater than about 0.3 mL/g. In at least one embodiment, the catalytic microspheres have an average cumulative pore volume of about 0.3 mL/g, about 0.35 mL/g, about 0.3 mL/g, about 0.325 mL/g, about 0.35 mL/g, about 0.375 mL/g, about 0.4 mL/g, about 0.425 mL/g, about 0.45 mL/g, about 0.475 mL/g, about 0.5 mL/g, about 0.525 mL/g, about 0.525 mL/g, about 0.55 mL/g, about 0.575 mL/g, about 0.6 mL/g, about 0.625 mL/g, about 0.65 mL/g, about 0.675 mL/g, about 0.7 mL/g, or greater, in any range defined therebetween (e.g., about 0.325 mL/g to about 0.45 mL/g, etc.).

In at least one embodiment, the catalytic microspheres comprise a bimodal pore distribution of macropores and mesopores. For example, in at least one embodiment, an average pore radius (BJH pore radius) of the mesopores is from about 10 Å to about 100 Å. In at least one embodiment, an average pore radius is about 10 Å, about 15 Å, about 20 Å, about 25 Å, about 30 Å, about 35 Å, about 40 Å, about 45 Å, about 50 Å, about 55 Å, about 60 Å, about 65 Å, about 70 Å, about 75 Å, about 80 Å, about 85 Å, about 90 Å, about 95 Å, about 100 Å, or greater, in any range defined therebetween (e.g., about 20 Å to about 30 Å).

Drying of the polymer/metal oxide droplets followed by removal of monodisperse polymer particles results in microspheres with substantially uniform and/or ordered macropores. The macropore diameters are dependent on the size of the polymer particles. Some “shrinkage” or compaction may occur upon polymer removal, providing macropore sizes somewhat smaller than the original polymer particle size, for example from about 10% to about 40% smaller than the polymer particle size.

In at least one embodiment, an average pore diameter of macropores in the catalytic microspheres can range from any of about 50 nm, about 60 nm, about 70 nm, 80 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm or about 440 nm to any of about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm, or about 800 nm, or within any subrange defined therebetween (e.g., about 100 nm to about 300 nm).

The average porosity of the metal oxide microspheres may be relatively high, for example from about 0.10 or about 0.30 to about 0.80 or about 0.90. Average porosity of a microsphere means the total pore volume, as a fraction of the volume of the entire microsphere. Average porosity may be called “volume fraction.”

In some embodiments, a porous microsphere may have a solid core (center) where the porosity is in general towards the exterior surface of the microsphere. In other embodiments, a porous microsphere may have a hollow core where a major portion of the porosity is towards the interior of the microsphere. In other embodiments, the porosity may be distributed throughout the volume of the microsphere. In other embodiments, the porosity may exist as a gradient, with higher porosity towards the exterior surface of the microsphere and lower or no porosity (solid) towards the center; or with lower porosity towards the exterior surface and with higher or complete porosity (hollow) towards the center.

For any porous microsphere, the average microsphere diameter is larger than the average macropore diameter, for example, the average microsphere diameter is at least about 10 times, about 15 times, about 20 times, about 25 times, about 30 times, about 35 times, or about 40 times larger than the average macropore diameter.

In some embodiments, the ratio of average microsphere diameter to average macropore diameter is, for example, from any of about 40/1, about 50/1, about 60/1, about 70/1, about 80/1, about 90/1, about 100/1, about 110/1, about 120/1, about 130/1, about 140/1, about 150/1, about 160/1, about 170/1, about 180/1 or about 190/1 to any of about 200/1, about 210/1, about 220/1, about 230/1, about 240/1, about 250/1, about 260/1, about 270/1, about 280/1, about 290/1, about 300/1, about 310/1, about 320/1, about 330/1, about 340/1, or about 350/1.

### ILLUSTRATIVE EXAMPLES

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1: Synthesis of Alumina with Ordered and Uniform Pore Structure

A formulation containing water, polymethyl methacrylate (PMMA) beads, and boehmite was spray dried to create solid particles. These particles were collected and calcined in a muffle furnace to remove the PMMA beads and convert the boehmite to alumina, yielding alumina porous microspheres.

### Example 2: Synthesis of Pd-Alumina with Ordered and Uniform Pore Structure

A formulation containing water, PMMA beads, boehmite, and palladium (II) nitrate was spray dried to create solid particles. These particles were collected and calcined in a muffle furnace to remove the PMMA beads, convert the boehmite to alumina and reduce the palladium nitrate into Pd nanoparticles, yielding alumina porous microspheres with Pd nanoparticles embedded therein.

### Example 3: Synthesis of Pd-Alumina Using Pd Nanoparticles with Ordered and Uniform Pore Structure

Palladium nanoparticles (Pd NPs) were first produced by reducing palladium (II) nitrate. A formulation containing water, PMMA beads, boehmite and Pd nanoparticles was spray dried to create solid particles. These particles were collected and calcined in a muffle furnace to remove the PMMA beads and convert the boehmite to alumina, yielding alumina porous microspheres with Pd nanoparticles embedded therein.

### Example 4: Impregnation of Example 1 with Pd (as Tetraamine-Pd-Hydroxide)

1 g of the material from Example 1 was impregnated to incipient wetness with a solution of tetraamine-Pd-hydroxide (BASF) in presence of the surfactant Surfynol 420. The material was dried at 110° C. and calcined at 550° C. for 2 hours.

### Comparative Example 1: Impregnation of Example 1 with Pd (as Nitrate)

1 g of the material from Example 1 was impregnated to incipient wetness with a solution of Pd-nitrate (BASF). The material was dried at 110° C. and calcined at 550° C. for 2 hours.

### Comparative Example 2: Impregnation of State of the Art Alumina with Pd

1 g of a thermally stable highly porous commercial alumina sample (Sasol TH100/150) was impregnated to incipient wetness with an aqueous Pd-tetraamine hydroxide solution (BASF). The material was dried at 110° C. and calcined at 550° C. (590° C. for catalytic tests) for 2 hours.

### Characterization and Catalytic Activity Tests

BET surface area, BJH pore volume, and BJH average pore radius was measured for the materials of each of the aforementioned examples.

To characterize pore volume and pore radius, samples were analyzed using a Micromeritics AutoPore series mercury porosimeter. The samples were heat treated at 350° C. for 1 hour before analysis to remove any volatile material. Samples were analyzed using a fixed pressure table (from 1.5 psi to 60,000 psi) and equilibration for 10 seconds at each of those pressures. Samples were run using an advancing and receding contact angle of 140° and the surface tension of mercury set at 480 dynes/cm (0.48 N/m). A blank analysis run was subtracted from the data. Data was calculated using the Washburn equation.

TABLE 1
Characterization of sample morphology

| | | N2 NJH Pore | |
|---|---|---|---|
| | BET surf. | volume | BJH avg. pore |
| Material | Area [m²/g] | [mL/g] | radius [Å] |
| Example 1 | 238.5 | 0.45 | 30.4 |
| Example 2 | 243.3 | 0.39 | 25.0 |
| Example 3 | 227.5 | 0.34 | 23.8 |
| Example 3 aged | 46.8 | 0.16 | 63.6 |
| Example 4 | 266.9 | 0.45 | 27.6 |
| Example 4 aged | 37.1 | 0.14 | 66.9 |
| Comparative Example 2 | 145.6 | 0.98 | 104.2 |
| Comp. Example 1 aged | 84.2 | 0.78 | 145.8 |

### Catalyst Aging

The Pd alumina samples were mixed with 5% alumina (Dispal23N4-80) dispersed in water. The resulting samples were dried at 110° C. and calcined at 590° C. for 1 hour in air. The resulting materials were crushed and sieved to 250-500 μm size. The samples were aged in 10% steam containing lean and rich gas mixtures by periodically switching the feed composition from lean (λ=1.05) to rich (λ=0.95). The samples were aged at 980° C. and 1050° C. for 5 hours at each temperature.

### Catalytic Activity Testing

100 mg of catalyst was diluted with corundum of the same particle size. Light-off curves were recorded from 175-450° C. in 25° C. steps after initial heat-up at λ=1 (stoichiometric) and cool-down and λ=0.95 (lean). The temperature of 50% conversion of the pollutant of interest (CO, propylene, NO) was recorded as T₅₀. The lower this temperature, the more active the catalyst. The data for the examples above is summarized in Table 2.

TABLE 2
Catalytic activity

| | T₅₀ | T₅₀ | T₅₀ |
|---|---|---|---|
| Material | CO (° C.) | HC (° C.) | NO (° C.) |
| Example 2 fresh | 217 | 238 | 246 |
| Example 2 aged 980° C. | 247 | 264 | 276 |
| Example 2 aged 1050° C. | 246 | 264 | 283 |
| Example 3 | 218 | 234 | 246 |
| Example 2 aged 980° C. | 230 | 245 | 279 |
| Example 2 aged 1050° C. | 258 | 268 | 293 |
| Comparative example 1 | 237 | 244 | 261 |
| Example 2 aged 980° C. | 264 | 272 | —* |
| Example 2 aged 1050° C. | 283 | 295 | —* |
| Comparative example 2 | 231 | 244 | 262 |
| Comp. Example | 267 | 284 | 395 |
| aged 980° C. | | | |
| Comp. Example | 278 | 294 | —* |
| aged 1050° C. | | | |

*50% conversion is not reached

It is apparent from this data that catalysts made by spray drying with Pd nanoparticles or with a Pd precursor are more resistant to aging than catalysts prepared via impregnation. Catalysts with high thermal resistance are based on spherical particles of defined pore size and ordered pore structure.

### Example 5: Synthesis of 0.5% Rh-Alumina with Ordered and Uniform Pore Structure

A formulation containing water, PMMA beads, boehmite, and rhodium nitrate was spray dried to create solid particles. The particles were collected and calcined in a muffle furnace to remove the PMMA beads, convert the boehmite to alumina and rhodium nitrate to rhodium oxide nanoparticles, yielding alumina porous microspheres with Rh nanoparticles embedded therein. The Rh loading was 0.5% by weight.

### Example 6: Synthesis of 0.25% Rh-Alumina with Ordered and Uniform Pore Structure

A formulation containing water, PMMA beads, boehmite, and rhodium nitrate was spray dried to create solid particles. The particles were collected and calcined in a muffle furnace to remove the PMMA beads, convert the boehmite to alumina and rhodium nitrate to rhodium oxide nanoparticles, yielding alumina porous microspheres with Rh nanoparticles embedded therein. The Rh loading was 0.25% by weight.

### Comparative Example 3: Synthesis of 0.5% Rh Alumina Reference Catalyst

Rhodium nitrate solution was impregnated on a γ-alumina support (a large-pore alumina having a specific surface area of about 150 m²/g). The impregnated material was dried at 110° C. and calcined at 550° C. for 2 hours. The Rh loading was 0.5% by weight after calcination. This sample is the reference sample for Example 5.

### Comparative Example 4: Synthesis of 0.25% Rh Alumina Reference Catalyst

Rhodium nitrate solution was impregnated on a state-of-the-art γ-alumina support. The impregnated material was dried at 110° C. and calcined at 550° C. for 2 hours. The Rh loading was 0.25% by weight after calcination. This sample is the reference sample for Example 6.

### Catalyst Evaluation Protocol

All catalysts were aged at 1050° C. for 5 hours with 10% H₂O under an alternating lean/rich feed (10 minutes 4% air/10 minutes 4% H₂/N₂). The aged catalysts were evaluated in a powder reactor using a light-off protocol with a 1=1 oscillating feed (1=0.95/1.05 cycled at 1 Hz) from 175 to 450° C. at a monolith equivalent GHSV of 70,000 h⁻¹. For light-off tests, the lean feed (1=1.05) included 0.7% CO, 0.22% H₂, 3000 ppm HC (C1) (propene/propane=2:1), 1500 ppm NO, 14% CO₂, 10% H₂O, and ˜1.8% O₂. The rich feed (1=0.95) included 2.33% CO, 0.77% H₂, 3000 ppm HC (C1), 1500 ppm NO, 14% CO₂, 10% H₂O and ˜0.7% O₂. The exact lambda values were fine-tuned by adjusting the O₂ level based on an upstream λ-sensor.

The catalysts were evaluated in the following sequence:
Run 1: Light-off
Run 2: Light-off
Run 3: Lambda-sweep at 450° C. from lean to rich
Run 4: Light-off

Run 1 was used as catalyst stabilization. Run 2 data were used for activity comparison. In addition to additional catalytic information, the lambda-sweep test (Run 3) can be considered as a reductive treatment for the catalysts since the catalysts were exposed to a reducing environment. Thus, Run 4 data were used to evaluate the effect of catalyst reduction (Run 4 vs. Run 2). The concentrations of carbon monoxide (CO), nitric oxide (NO) and hydrocarbon (HC) were continuously measured before and after catalysts. The conversion of a component (CO, NO, or HC) was calculated as the percent of disappearance, i.e., Conversion=(Inlet concentration−Outlet concentration)/Inlet concentration×100%. Catalyst activity was also characterized by catalyst light-off temperature, which is defined as the temperature required to achieve 50% conversion in a conversion-temperature plot. Light-off temperature is denoted as T50. Light-off temperatures for CO, NO, and HC were expressed as CO T50, NO T50, and HC T50, respectively.

All catalysts were aged at 1050° C. for 5 hours with 10% H₂O under an alternating lean/rich feed (10 minutes 4% air/10 minutes 4% H₂/N₂).

### Catalyst Evaluation Results

Table 3 compares Run 2 T50 for CO, NO, and HC, after aging at 1050° C., between Example 5 (0.5% Rh-alumina with ordered and uniform pore structure) and Comparative Example 3 (0.5% Rh/alumina reference), and between Example 6 (0.25% Rh-alumina with ordered and uniform pore structure) and Comparative Example 4 (0.25% Rh/alumina reference). The Rh catalysts with ordered and uniform pore structure (Examples 5 and 6) are considerably more active (lower T50) than their corresponding reference catalysts (Comparative Examples 3 and 4). Example 6, which contains 0.25% Rh, showed the same performance (T50) as Comparative Example 3, which contains the 0.5% Rh.

TABLE 3
Catalytic activity of supported Rh catalysts (Run 2 data)

| | T₅₀ | T₅₀ | T₅₀ |
|---|---|---|---|
| Material | CO (° C.) | HC (° C.) | NO (° C.) |
| Example 5 aged at 1050° C. | 263 | 273 | 267 |
| Comparative Example | 289 | 312 | 294 |
| 3 aged at 1050° C. | | | |
| Example 6 aged at 1050° C. | 289 | 313 | 295 |
| Comparative Example | 342 | 376 | 340 |
| 4 aged at 1050° C. | | | |

Table 4 compares Run 4 T50 for CO, NO, and HC, after aging at 1050° C., between Example 5 (0.5% Rh-alumina with ordered and uniform pore structure) and Comparative Example 3 (0.5% Rh/alumina reference), and between Example 6 (0.25% Rh-alumina with ordered and uniform pore structure) and Comparative Example 4 (0.25% Rh/alumina reference). After the reductive treatment (Run 3), all catalysts became more active (reduced T50). However, the same conclusion can be made in terms of their activity ranking. An Rh catalyst with ordered and uniform pore structure can achieve performance equivalency to a conventionally prepared Rh catalyst but with about one half of the Rh (Example 6 vs. Comparative Example 3).

TABLE 4
Catalytic activity of supported Rh catalysts
after reductive activation (Run 4 data)

| | T₅₀ | T₅₀ | T₅₀ |
|---|---|---|---|
| Material | CO (° C.) | HC (° C.) | NO (° C.) |
| Example 5 aged at 1050° C. | 238 | 247 | 254 |
| after reductive treatment | | | |
| Comparative Example 3 aged at | 262 | 295 | 265 |
| 1050° C. after reductive treatment | | | |
| Example 6 aged at 1050° C. | 262 | 282 | 266 |
| after reductive treatment | | | |
| Comparative Example 4 aged at | 287 | 325 | 286 |
| 1050° C. after reductive treatment | | | |

### SEM Characterization of Rh Catalysts

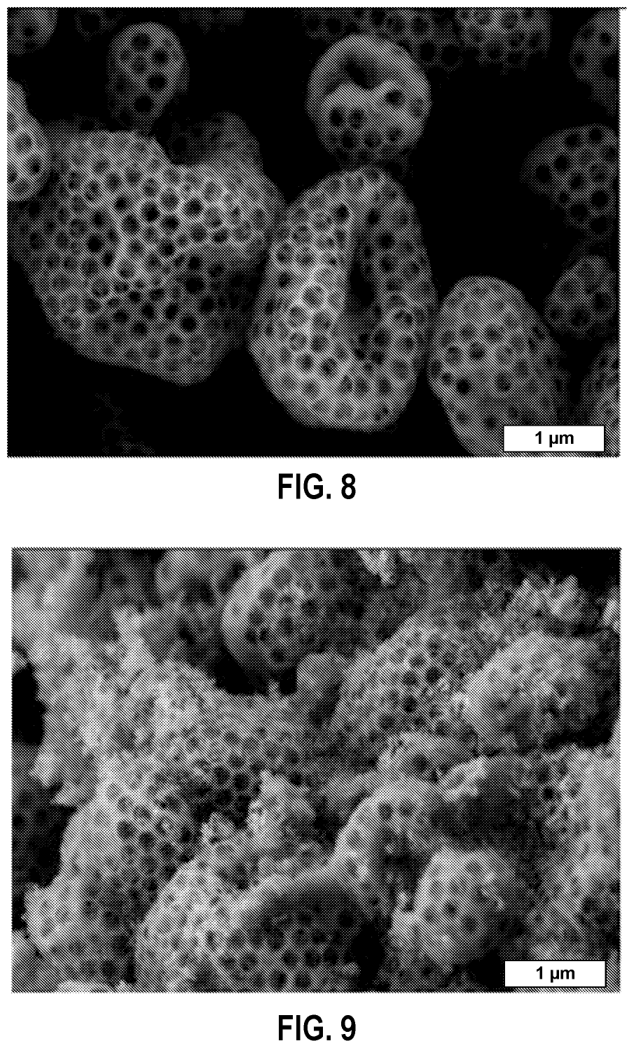

FIG. 8 is an SEM image of surface topology of fresh 0.5% Rh-alumina with ordered and uniform pore structure (Example 5). FIG. 9 is an SEM image of surface topology of 1050° C. aged 0.5% Rh-alumina with ordered and uniform pore structure (Example 5).

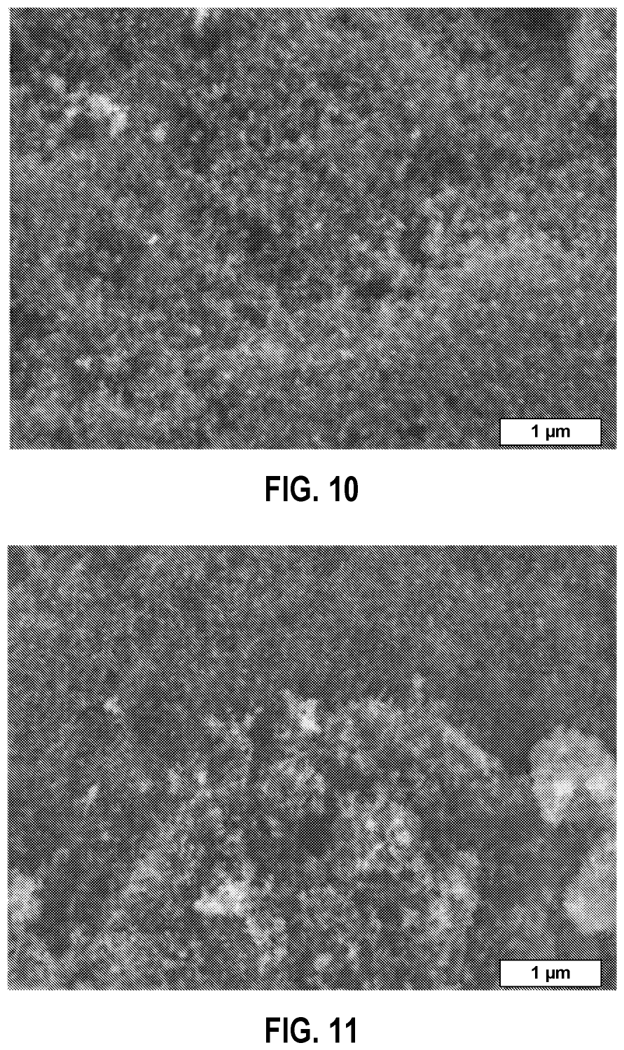

FIG. 10 is an SEM image of surface topology of a fresh 0.5% Rh-alumina reference (Comparative Example 3). FIG. 11 is an SEM image of surface topology of a 1050° C. aged 0.5% Rh-alumina reference (Comparative Example 3).

### Diffuse Reflectance Infrared Fourier Transform Spectroscopy (DRIFTS) of Rh Catalysts

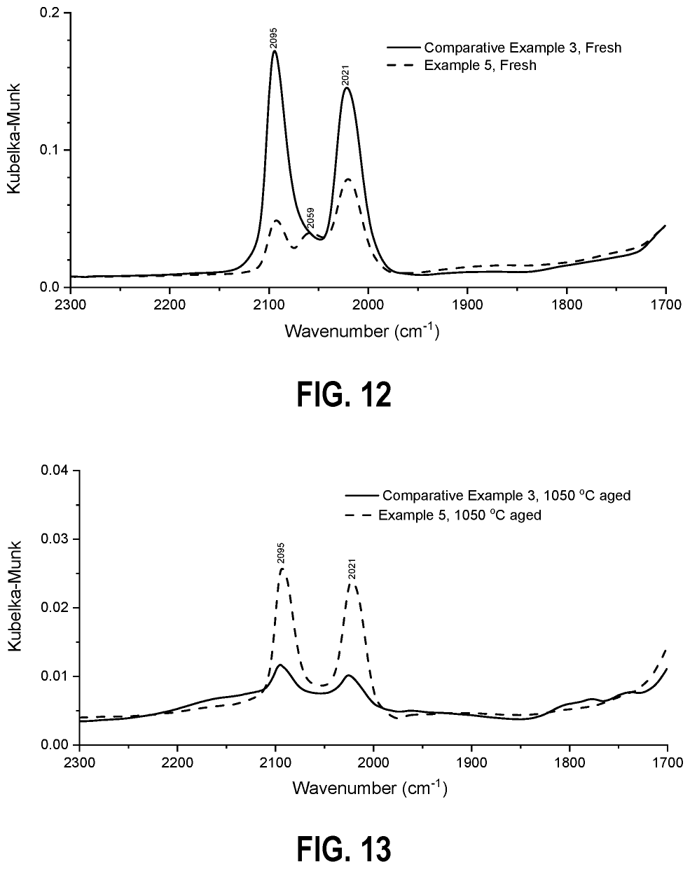

FIG. 12 shows DRIFTS of CO adsorbed on fresh Rh catalysts with 0.5% Rh (Example 5 and Comparative Example 3). The CO adsorption peaks at 2095 and 2021 cm⁻¹ are attributable to two CO molecules adsorbed on one surface Rh⁺ ion, (CO)₂Rh (I). The CO adsorption peak around 2059 cm⁻¹ can be attributed to CO adsorbed on metallic Rh. FIG. 12 shows that a significant fraction of Rh in fresh Example 5 is in metallic form, while all Rh species in Comparative Example 3 are in oxide form.

FIG. 13 shows DRIFTS of CO adsorbed on 1050° C. aged Rh catalysts with 0.5% Rh (Example 5 and Comparative Example 3). After aging, all Rh species are in oxide form in both samples. The CO adsorption peak intensity is significantly higher on the aged Example 5, which indicates there are much more surface Rh species on aged Example 5 than on aged comparative Example 3. This highlights the unique and advantageous ability of the ordered alumina structure prepared in accordance with the embodiments described herein in stabilizing Rh against high temperature aging.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment,” in various places throughout this specification are not necessarily all referring to the same embodiment, and such references mean “at least one.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1-43. (canceled)

44. A method of forming catalytic microspheres, the method comprising:
generating liquid droplets from an aqueous dispersion comprising a polymer material and a metal oxide material or precursor;
drying the liquid droplets to provide dried particles comprising the polymer material, the metal oxide material or precursor, and the catalytic metal material or precursor;
calcining or sintering the dried particles to remove the polymer material and form the metal oxide microspheres each comprising a matrix of the metal oxide defining a porous network;
introducing a catalytic metal material or precursor into a porous network within the metal oxide microspheres to form impregnated microspheres; and
drying and calcining the impregnated microspheres to form the catalytic microspheres.

45. The method of claim 44, wherein the porous network is an ordered or partially ordered array of macropores.

46. The method of claim 44, wherein the porous network is a disordered array of macropores.

47. The method of claim 44, wherein the catalytic metal material or precursor comprises a catalytic metal selected from platinum, palladium, rhodium, copper, manganese, nickel, cobalt, zinc, indium, gallium, zirconium, cerium, vanadium, molybdenum, or rhenium.

48. The method of claim 44, wherein calcining the impregnated microspheres results in the formation of catalytic metal or metal oxide nanoparticles within the catalytic microspheres.

49. The method of claim 44, wherein an average surface area of the catalytic microspheres is greater than about 100 m²/g.

50. The method of claim 44, wherein a cumulative pore volume of the catalytic microspheres is greater than 0.3 mL/g.

51. The method of claim 44, wherein the catalytic microspheres comprise a bimodal pore distribution of macropores and mesopores, wherein an average pore radius of the mesopores is from about 10 Å to about 100 Å.

52. The method of claim 44, wherein introducing the catalytic metal material or precursor into the porous network comprises utilizing an incipient wetness impregnation process.

53. The method of claim 44, wherein the polymer material comprises a polymer selected from poly(meth)acrylic acid, poly(meth)acrylates, polymethyl methacrylate polystyrenes, polyacrylamides, polyethylene, polypropylene, polylactic acid, polyacrylonitrile, a co-polymer of methyl methacrylate and [2-(methacryloyloxy)ethyl]trimethylammonium chloride, derivatives thereof, salts thereof, copolymers thereof, or mixtures thereof.

54. The method of claim 44, wherein the polymer material is in the form of nanoparticles, and wherein the nanoparticles have an average diameter from about 50 nm to about 500 nm.

55. The method of claim 44, wherein the metal oxide material or precursor comprises a metal oxide selected from silica, titania, alumina, zirconia, ceria, iron oxides, zinc oxide, indium oxide, tin oxide, chromium oxide, or combinations thereof.

56. The method of claim 44, wherein the metal oxide material is in the form of metal oxide particles having an average diameter from about 1 nm to about 120 nm.

57. The method of claim 44, wherein the catalytic microspheres have an average diameter from about 0.5 μm to about 100 μm.

58. The method of claim 44, wherein generating the liquid droplets is performed using a microfluidic process.

59. The method of claim 44, wherein generating and drying the liquid droplets is performed using a spray-drying process.

60. The method of claim 44, wherein generating the liquid droplets is performed using a vibrating nozzle.

61. Catalytic microspheres prepared by the method of claim 44.

62. A composition comprising the catalytic microspheres of claim 61.

63. A catalytic device comprising:
a substrate; and
the catalytic microspheres of claim 61.
